(19) United States
(12) Patent Application Publication
(10) Pub. No.: US 2022/0416717 A1
(43) Pub. Date: Dec. 29, 2022

(54) PHOTOVOLTAIC MODULE STRUCTURE

(71) Applicant: HYUNDAI SOLARTEC, Gwangju (KR)

(72) Inventor: Su Ryeon PARK, Gwangju (KR)

(73) Assignee: HYUNDAI SOLARTEC, Gwangju (KR)

(21) Appl. No.: 17/780,990

(22) PCT Filed: Nov. 29, 2019
(86) PCT No.: PCT/KR2019/016714

§ 371 Date: May 29, 2022

(30) Foreign Application Priority Data
Nov. 29, 2019 (KR) 10-2019-0156492

(51) Int. Cl. H02S 20/30; H02S 30/10; H02S 50/10

(52) U.S. Cl. CPC H02S 20/30; H02S 30/10; H02S 50/10

(57) ABSTRACT

A photovoltaic module structure according to the present invention comprises: a stand, which is fixed to the ground, is provided at a predetermined height, has a hinge-coupled part provided at the upper end thereof, and has a pin hole formed below the hinge coupling part; a frame which is hinge-coupled to the hinge coupling part of the stand so as to be rotatable upward and downward and which has a surface to which solar panels are attached; a flange, which is fixed to the rear surface of the frame, has the center of the hinge coupling between the frame and the stand as the center thereof, and has a plurality of pin holes formed at predetermined intervals along an arc of a predetermined radius corresponding to the distance between the hinge coupling part and the pin hole of the stand; a fixing pin inserted into any one of the plurality of pin holes of the flange and the pin hole of the stand in a state in which the pin hole of the flange is matched with the pin hole of the stand, so that the flange can be fixed to the frame in a state in which the flange is rotated with respect to the stand; an FBG sensor provided in at least any one from among the stand, the frame, and the flange; and a diagnosis unit for diagnosing stability by analyzing the signals of the FBG sensor. When the photovoltaic module structure according to the present invention is used, stability can be diagnosed in real time.

### TECHNICAL FIELD

The present invention relates to a photovoltaic module structure capable of diagnosing in real time whether there are stability problems, such as damage or deformation, caused by external factors such as wind or hail.

### BACKGROUND ART

In general, photovoltaic power generation refers to a power generation method that converts light coming from the sun into electrical energy using photovoltaic effect. Photovoltaic power generation is distinguished from solar thermal power generation, which generates electricity using thermal energy of light, in that it directly converts light energy into electrical energy.

Korean Patent No. 10-2032722 (registered on Oct. 10, 2019) discloses “a solar power panel inspection system using a drone.” In this prior patent document, a technology including a flying object that divides a solar panel group into a plurality of regions based on an image of the panel group captured by a camera, that shoots images of solar panels that are included in a central server and solar panel group which allocate ID of a solar panel to each region, and that transmits ID information of the photographed solar panel and an image obtained as a result of the photographing to the central server.

However, the prior technology only diagnoses the pollution state or damage of a solar panel, and cannot diagnose the stability of a structure due to external environmental factors, such as wind or hail, in real time. Accordingly, there is a limitation in maintaining and repairing a panel or a structure.

### DISCLOSURE

### Technical Problem

Therefore, the present invention has been made in view of the above problems, and it is one object of the present invention to provide a photovoltaic module structure capable of performing stability diagnosis, such as whether a structure is deformed or damaged due to external factors such as wind or hail, in real time and, accordingly, allowing rapid repair.

### Technical Solution

In accordance with an aspect of the present invention, the above and other objects can be accomplished by the provision of a photovoltaic module structure, including: a support fixed to ground, installed at a predetermined height, provided with a hinge-coupled part formed at an upper end thereof, and provided with a pin hole formed below the hinge-coupled part; a frame hinge-coupled so as to be rotatable up and down to the hinge-coupled part of the support and provided with solar panels attached to a surface thereof; a flange fixed to a rear surface of the frame, and provided with a plurality of pin holes that are formed at a predetermined interval along an arc having a predetermined radius corresponding to a distance between the hinge-coupled part of the support and the pin hole thereof with respect to a hinge-coupled center of the frame and the support; a frame inserted, in a state that any one of the plural pin holes of the flange is matched with the pin hole of the support, into the pin hole of the flange and the pin hole of the support to be fixed to the frame in a rotated state with respect to the support; an FBG sensor installed at at least one of the support, the frame, and the flange; and a diagnostic part configured to diagnose stability by analyzing a signal of the FBG sensor.

The FBG sensor may be lengthily installed at the flange along the arc, and both ends of FBG sensor may be fixed to the frame at both ends of the arc.

The FBG sensor may be installed at the hinge-coupled part of the support and the frame; and, in the diagnostic part, a reference value for comparing and analyzing signals of the FBG sensor may be preset according to relative rotational displacement of the frame with respect to the support.

The FBG sensor may be installed over a pin hole side of the support and the flange; and, in the diagnostic part, a reference value for comparing and analyzing signals of the FBG sensor may be preset according to relative rotational displacement of the frame with respect to the support.

The FBG sensor may be installed at the frame, and may include a lateral direction line installed in a zigzag manner along a lateral direction of the frame; and a longitudinal direction line installed in a zigzag manner along a longitudinal direction of the frame.

### Advantageous Effects

The photovoltaic module structure according to the present invention includes an FBG sensor integrally installed without structural interference, thereby being capable of diagnosing stability problems, such as damage or deformation, caused by external factors such as wind or hail in real time and rapidly repairing the same.

### DESCRIPTION OF DRAWINGS

FIG. 1 illustrates a side view of a photovoltaic module structure according to an embodiment of the present invention.

FIG. 2 is a side view illustrating a relative rotation state of a frame of the photovoltaic module structure illustrated in FIG. 1.

FIG. 3 is a plan view illustrating an FBG sensor line installed in the frame illustrated in FIG. 1.

### BEST MODE

Hereinafter, a preferred embodiment of the present invention will be described with reference to the accompanying drawings.

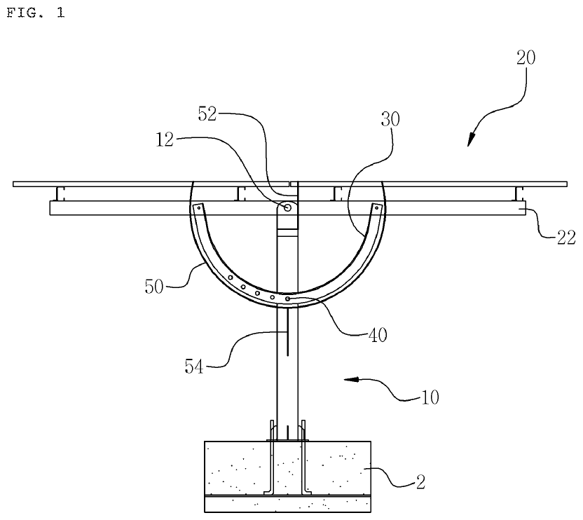

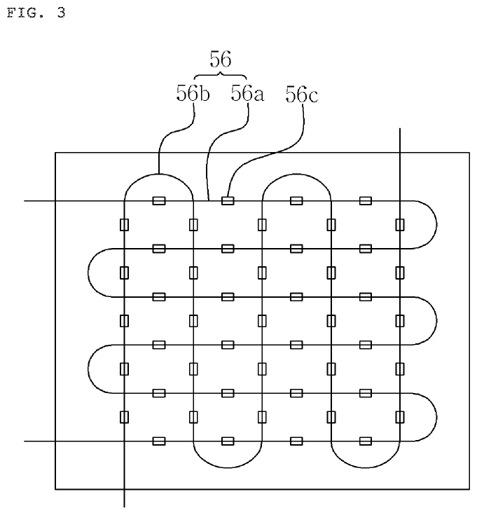

As illustrated in FIGS. 1 to 3, a photovoltaic module structure according to the present invention includes a support 10; a frame 20 to which a solar panel is attached; a flange 30; a fixing pin 40; an FBG sensor; and a diagnostic part (not shown).

The support 10 supports the frame 20 at a predetermined height with respect to the ground. That is, the support 10 is formed by a predetermined height in a vertical direction, a lower end thereof is fixed to the ground 2 in a manner of being embedded in concrete, and an upper end thereof is coupled with the frame 20. That is, the upper end of the support 10 is provided with a hinge-coupled part for hinge coupling with the frame 20. In addition, the support 10 is provided with a pin hole into which the fixing pin 40 is putted, wherein the pin hole is formed at a predetermined distance lower than the hinge-coupled part of the support 10. The pin hole of the support 10 may be threaded so that the fixing pin 40 can be bolted. The pin hole of the support 10 is opened along a lateral direction of the frame 20. The support 10 may be formed as one long partition wall along the lateral direction of the frame 20, or a plurality of support 10 may be formed like pillars while maintaining a predetermined interval along the lateral direction of the frame 20.

The frame 20 may be supported by the support 10 to support the solar panel attached to the surface. The frame 20 may be formed in a planar shape having a predetermined area.

The frame 20 is coupled to the upper end of the support 10 so as to be rotatable up and down within a predetermined angular range and particularly, is hinge-coupled so as to be rotatable up and down with respect to the support 10 within the predetermined angular range. That is, a hinge hole opened along the lateral direction of the frame 20 is formed in the hinge-coupled part of the support 10. A rib is formed on the rear surface of the frame 20 to protrude in the vertical direction with respect to the frame 20, and a hinge hole opened in the lateral direction of the frame 20 is formed in the rib of the frame 20. A plurality of ribs may be provided on the frame 20 to correspond to the number of the supports 10 along the lateral direction of the frame 20. In addition, when a hinge pin is inserted into the hinge hole of the support 10 and the hinge hole of the frame 20 in a state that of the hinge hole of the support 10 coincides with the hinge hole of the frame 20 along the lateral direction of the frame 20, the support 10 is hinge-coupled with the frame 20.

The flange 30 serves to fix the relative rotational displacement of the frame 20 with respect to the support 10. The flange 30 is fixed to the rear surface of the frame 20. The flange 30 is centered on the hinge-coupled center of the frame 20 and the support 10, and includes a plurality of pin holes that are formed at a predetermined interval along an arc having a predetermined radius corresponding to a distance between the hinge-coupled part of the support 10 and the pin hole thereof. The flange 30 may be formed in a semi-ring shape that corresponds to the circular arc.

The fixing pin 40 is fixed to the frame 20 in a rotated state with respect to the support 10. The fixing pin 40 is inserted into the pin hole of the flange 30 and the pin hole of the support 10 in the state that any one of the plural pin holes of the flange 30 is matched with the pin hole of the support 10. The fixing pin 40 may be a bolt.

The FBG sensor is installed at at least one of the support 10, the frame 20, and the flange 30 to diagnose the stability of the photovoltaic module structure of the present invention to detect damage or deformation and detect damage or deformation thereof. The FBG sensor is also called a fiber bragg grating sensor, has a unique wavelength value, and is hardly affected by electromagnetic waves, so that it may be installed around a solar cell. In addition, since the FBG sensor has a very high tensile force per unit area, but has a very small diameter, it may be easily installed without structural interference with surroundings. In addition, as described below, the FBG sensor may also be installed at a moving part such as the hinge-coupled part of the support 10 and the frame 20. In addition, the FBG sensor may obtain measurements at multiple points along a line.

The FBG sensor is lengthily installed at the flange 30 along the arc and includes a first sensor line 50 whose both ends are respectively fixed to the frame 20 at both ends of the arc of the flange 30. It may be diagnosed by the first sensor line 50 whether the relative displacement between the frame 20 and the flange 30, i.e., whether the coupled part between the frame 20 and the flange 30 is loosened, damaged, deformed, or the like.

The FBG sensor includes a second sensor line 52 installed at the hinge-coupled part of the support 10 and the frame 20. That is, one end of the second sensor line 52 may be fixed to hinge-coupled part of the support 10, and another end of the second sensor line 52 may be fixed to a hinge hole side of the frame 20. It may be diagnosed by the second sensor line 52 whether the hinge-coupled part of the support 10 and the frame 20 is loosened, damaged, deformed, or the like.

The FBG sensor includes a third sensor line 54 that is installed over a pin hole side of the support 10 and the flange 30. That is, one end of the third sensor line 54 may be fixed to the pin hole side of the support 10, and another end of the third sensor line 54 may be fixed to an outer peripheral end side of the flange 30. It may be diagnosed by the third sensor line 54 whether the coupling between the support 10 and the flange 30 by the fixing pin is loosened, damaged, deformed, or the like.

The FBG sensor includes a fourth sensor line 56 installed at the frame 20. The third sensor line 54 includes a lateral direction line 56a installed in a zigzag manner along a lateral direction of the frame 20; and a longitudinal direction line 56b installed in a zigzag manner along a longitudinal direction of the frame 20. A plurality of measurement points 56c are formed on the lateral direction line 56a and the longitudinal direction line 56b along the lateral direction line 56a and longitudinal direction line 56b. Accordingly, local damage or deformation of the frame 20 may be diagnosed by the third sensor line 54.

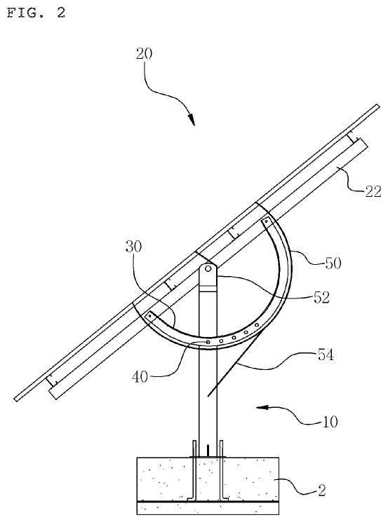

In the diagnostic part, a reference value for comparing and analyzing signals of the FBG sensor is preset. The reference value is a value measured by the FBG sensor in a steady state. Accordingly, when a measured value is input from the FBG sensor, the diagnostic part compares and analyzes the measured value from the FBG sensor with the reference value to diagnose a stability problem such as damage or deformation. In particular, in the case of the second sensor line 52 and the third sensor line 54, the diagnostic part presets a plurality of reference values according to the relative rotational displacement of the frame 20 with respect to the support 10. That is, a reference value when the frame 20 is in a horizontal state as shown in FIG. 1, and a reference value is also set when the frame 20 is in an inclined state as shown in FIG. 2. When the frame 20 is intentionally and relatively rotated with respect to the support 10, the diagnostic part compares and analyzes values measured by the FBG sensor while changing a reference value according to the relative rotational displacement of the frame 20 by manually inputting the rotation into the diagnostic part or by automatically inputting in conjunction with a sensor or the like, so that the rotation is not diagnosed as being broken or deformed.

As described above, the technical ideas described in the embodiments of the present invention may be independently implemented, or may be implemented in a combined form. In addition, although the present invention has been described through the accompanying drawings and the embodiments disclosed in the detailed description, these are merely provided as exemplary examples and, accordingly, various modifications and equivalent other embodiments thereof can be made by those skilled in the art to which the present invention pertains. Therefore, the technical protection scope of the present invention should be defined by the following claims.

### INDUSTRIAL APPLICABILITY

The present invention can be widely used in the field of safety diagnosis and monitoring of photovoltaic power generation facilities.

1. A photovoltaic module structure, comprising:
a support fixed to ground, installed at a predetermined height, provided with a hinge-coupled part formed at an upper end thereof, and provided with a pin hole formed below the hinge-coupled part;
a frame hinge-coupled so as to be rotatable up and down to the hinge-coupled part of the support and provided with solar panels attached to a surface thereof;
a flange fixed to a rear surface of the frame, and provided with a plurality of pin holes that are formed at a predetermined interval along an arc having a predetermined radius corresponding to a distance between the hinge-coupled part of the support and the pin hole thereof with respect to a hinge-coupled center of the frame and the support;
a frame inserted, in a state that any one of the plural pin holes of the flange is matched with the pin hole of the support, into the pin hole of the flange and the pin hole of the support to be fixed to the frame in a rotated state with respect to the support;
an FBG sensor installed at at least one of the support, the frame, and the flange; and
a diagnostic part configured to diagnose stability by analyzing a signal of the FBG sensor.

2. The photovoltaic module structure according to claim 1, wherein the FBG sensor is lengthily installed at the flange along the arc, and opposite ends of FBG sensor are fixed to the frame at both ends of the arc.

3. The photovoltaic module structure according to claim 1, wherein the FBG sensor is installed at the hinge-coupled part of the support and the frame; and, in the diagnostic part, a reference value for comparing and analyzing signals of the FBG sensor is preset depending on relative rotational displacement of the frame with respect to the support.

4. The photovoltaic module structure according to claim 1, wherein the FBG sensor is installed over a pin hole side of the support and the flange; and, in the diagnostic part, a reference value for comparing and analyzing signals of the FBG sensor is preset depending on relative rotational displacement of the frame with respect to the support.

5. The photovoltaic module structure according to claim 1, wherein the FBG sensor is installed at the frame, and comprises a lateral direction line installed in a zigzag manner along a lateral direction of the frame; and a longitudinal direction line installed in a zigzag manner along a longitudinal direction of the frame.
